(19) United States
(12) Patent Application Publication
(10) Pub. No.: US 2024/0095758 A1
(43) Pub. Date: Mar. 21, 2024

(54) SYSTEM AND METHOD OF TRACKING AND REDUCING CARBON EMISSIONS

(71) Applicant: DigiKerma, Inc., Herndon, VA (US)

(72) Inventor: Irfan K. Ali, Herndon, VA (US)

(21) Appl. No.: 18/469,051

(22) Filed: Sep. 18, 2023

Related U.S. Application Data
(60) Provisional application No. 63/408,283, filed on Sep. 20, 2022.
(60) Provisional application No. 63/479,199, filed on Jan. 10, 2023.

(51) Int. Cl. G06Q 30/018

(52) U.S. Cl. CPC G06Q 30/018; G06Q 2220/165

(57) ABSTRACT

Controlling and managing atmospheric carbon emissions by a process of: generating a certificate of sink (COS) corresponding to a quantity of carbon sequestered by a carbon sequestering entity (CSE); generating a first s-NFT by minting the first-COS; publishing the first-sNFT on an exchange; generating a first tokenized carbon credits (first-TCCs) by tokenizing an amount of carbon represented by the first-sNFT; storing the first-TCCs on a first-CSE wallet; generating a first unique carbon tag (UCT) from the first-sNFT, the UCT being associated with: a first dataset identifying the first-sNFT; a second dataset identifying the number of TCCs associated with the first-sNFT, corresponding with an amount of carbon identified under the first-COS and the status of each TCC; a third dataset identifying a location of each of the first-TCCs; storing the first-UCT and datasets on a server associated with the exchange; and triggering the first-UCT with each transaction associated with the first-TCCs.

### CROSS-REFERENCE TO RELATED APPLICATIONS

This application claims the benefit of United Stated Provisional Application No. 63/408,283 filed Sep. 20, 2022 and Untied States Provisional Application No. 63/479,1999 filed Jan. 10, 2023, the disclosure of each of which is incorporated herein by reference in its entirety.

### BACKGROUND

Embodiments described herein relate to carbon emissions and more specifically a system and method of tracking and reducing carbon emissions. The embodiments are provided because there is a desire to control the output of carbon emissions so as to balance emissions with sequestering activities and diminish carbon emissions over time.

### BRIEF SUMMARY

Disclosed is a system for controlling and managing atmospheric carbon emissions, wherein the system includes one or more controllers configured for executing a first process of: receiving input indicative of sequestering a first quantity of carbon by a first carbon sequestering entity (CSE); generating a first certificate of sink (COS) corresponding to the first quantity of sequestered carbon; generating a first s-NFT, that is an NFT related to sequester activities, by minting the first-COS; publishing the first-sNFT on an exchange; generating a first amount of available tokenized carbon credits (first-TCCs) by tokenizing an amount of carbon represented by the first-sNFT; storing the first-TCCs on a first-CSE wallet; generating a first unique carbon tag (UCT) from the first-sNFT, the UCT being associated with datasets, including: a first dataset that identifies the first-sNFT; a second dataset that identifies the number of TCCs associated with the first-sNFT, which corresponds with an amount of carbon identified under the first-COS and the status of each TCC; a third dataset that identifies a storage or published location of each of the first-TCCs; storing the first-UCT and the datasets on a server associated with the exchange; and triggering the first-UCT for reviewing and updating the datasets with each transaction associated with the first-TCCs until the first-TCCs are retired following offsetting activities.

In addition to one or more features of the system, or as an alternate, one TCC or a fraction thereof corresponds with 1 metric ton or a fraction thereof of sequestered carbon.

In addition to one or more features of the system, or as an alternate, the one or more controllers configured for executing a second process of: receiving a request from the first-CSE to list for sale the first-TCCs on the exchange; or receiving a request from the first-CSE to list for sale the TCCs stored within the first-CSE wallet that are associated with different COSs, and applying a FIFO analysis to identify earlier generated ones of the TCCs to list on the exchange; transferring TCCs to the exchange to define listed-TCCs; and triggering the UCTs that are linked to the listed-TCC by updating the third dataset to indicate the listed-TCCs are listed on the crypto exchange.

In addition to one or more features of the system, or as an alternate, the one or more controllers configured for executing a third process of: receiving a request by a first carbon offsetting entity (COE) to acquire one or more of the listed-TCCs from the exchange; selling the one or more of the listed—TCCs to the COE, to define purchased-TCCs; transferring the purchased-TCCs to the to a first-COE wallet; triggering the UCTs linked with the purchased-TCCs to indicate a decrease in available TCCs for sale, by: updating the second dataset to identify a sale to the first-COE of the purchased-TCCs; and updating the third dataset to indicate the purchased-TCCs are located on the first-COE storage unit; and transferring payment from the first-COE to sellers of the purchased-TCCs, via the exchange, in the form of USDC(s), USDT(s) or DAI(s).

In addition to one or more features of the system, or as an alternate, the one or more controllers configured for executing a fourth process of: offsetting carbon by the first-COE, wherein: the purchased-TCCs that account for the offset carbon are each associated with the first-UCT and define offset-TCCs; or the purchased-TCCs that account for the offset carbon are associated with different COSs, and the system applies a FIFO analysis to to identify the purchased-TCCs that were generated first and thereby define the offset-TCCs; retiring the offset-TCCs; generating a first certificate of offset (COO) from the offset-TCCs; generating a first oNFT, that is an NFT related to offset activities, by minting the first-COO; publishing the first-oNFT on the first-exchange; triggering the UCTs linked with the offset-TCCs to update the datasets, by: updating the second dataset in the UCTs to identify that the offset-TCCs are retired; and updating the third dataset to remove reference to the retired TCCs.

Further disclosed is a method for controlling and managing atmospheric carbon emissions, wherein the method includes one or more controllers executing a first process of: receiving input indicative of sequestering a first quantity of carbon by a first carbon sequestering entity (CSE); generating a first certificate of sink (COS) corresponding to the first quantity of sequestered carbon; generating a first s-NFT, that is an NFT related to sequester activities, by minting the first-COS; publishing the first-sNFT on an exchange; generating a first amount of available tokenized carbon credits (first-TCCs) by tokenizing an amount of carbon represented by the first-sNFT; storing the first-TCCs on a first-CSE wallet; generating a first unique carbon tag (UCT) from the first-sNFT, the UCT being associated with datasets, including: a first dataset that identifies the first-sNFT; a second dataset that identifies the number of TCCs associated with the first-sNFT, which corresponds with an amount of carbon identified under the first-COS and the status of each TCC; a third dataset that identifies a storage or published location of each of the first-TCCs; storing the first-UCT and the datasets on a server associated with the exchange; and triggering the first-UCT for reviewing and updating the datasets with each transaction associated with the first-TCCs until the first-TCCs are retired following offsetting activities.

In addition to one or more features of the method, or as an alternate, one TCC or a fraction thereof corresponds with 1 metric ton or a fraction thereof of sequestered carbon.

In addition to one or more features of the method, or as an alternate, the method includes the one or more controllers executing a second process of: receiving a request from the first-CSE to list for sale the first-TCCs on the exchange; or receiving a request from the first-CSE to list for sale the TCCs stored within the first-CSE wallet that are associated with different COS s, and applying a FIFO analysis to identify earlier generated ones of the TCCs to list on the exchange; transferring TCCs to the exchange to define listed-TCCs; and triggering the UCTs that are linked to the listed-TCC by updating the third dataset to indicate the listed-TCCs are listed on the crypto exchange.

In addition to one or more features of the method, or as an alternate, the method includes the one or more controllers configured executing a third process of: receiving a request by a first carbon offsetting entity (COE) to acquire one or more of the listed-TCCs from the exchange; selling the one or more of the listed—TCCs to the COE, to define purchased-TCCs; transferring the purchased-TCCs to the to a first-COE wallet; triggering the UCTs linked with the purchased-TCCs to indicate a decrease in available TCCs for sale, by: updating the second dataset to identify a sale to the first-COE of the purchased-TCCs; and updating the third dataset to indicate the purchased-TCCs are located on the first-COE storage unit; and transferring payment from the first-COE to sellers of the purchased-TCCs, via the exchange, in the form of USDC(s), USDT(s) or DAI(s).

In addition to one or more features of the method, or as an alternate, the method includes the one or more controllers executing a fourth process of: offsetting carbon by the first-COE, wherein: the purchased-TCCs that account for the offset carbon are each associated with the first-UCT and define offset-TCCs; or the purchased-TCCs that account for the offset carbon are associated with different COS s, and the system applies a FIFO analysis to to identify the purchased-TCCs that were generated first and thereby define the offset-TCCs; retiring the offset-TCCs; generating a first certificate of offset (COO) from the offset-TCCs; generating a first oNFT, that is an NFT related to offset activities, by minting the first-COO; publishing the first-oNFT on the first-exchange; triggering the UCTs linked with the offset-TCCs to update the datasets, by: updating the second dataset in the UCTs to identify that the offset-TCCs are retired; and updating the third dataset to remove reference to the retired TCCs.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The subject matter which is regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 shows a system for tracking and reducing carbon emissions, according to an embodiment;

FIG. 2 shows a process of minting an sNFT for a first-CSE, and generating TCCs and a first-UCT; according to an embodiment;

FIG. 3 shows a process of selling TCCs by the first-CSE;

FIG. 4 shows a process of selling TCCs to a first carbon offsetting entity (first-COE); and

FIG. 5 shows a process of offsetting carbon by the first-COE.

### DETAILED DESCRIPTION

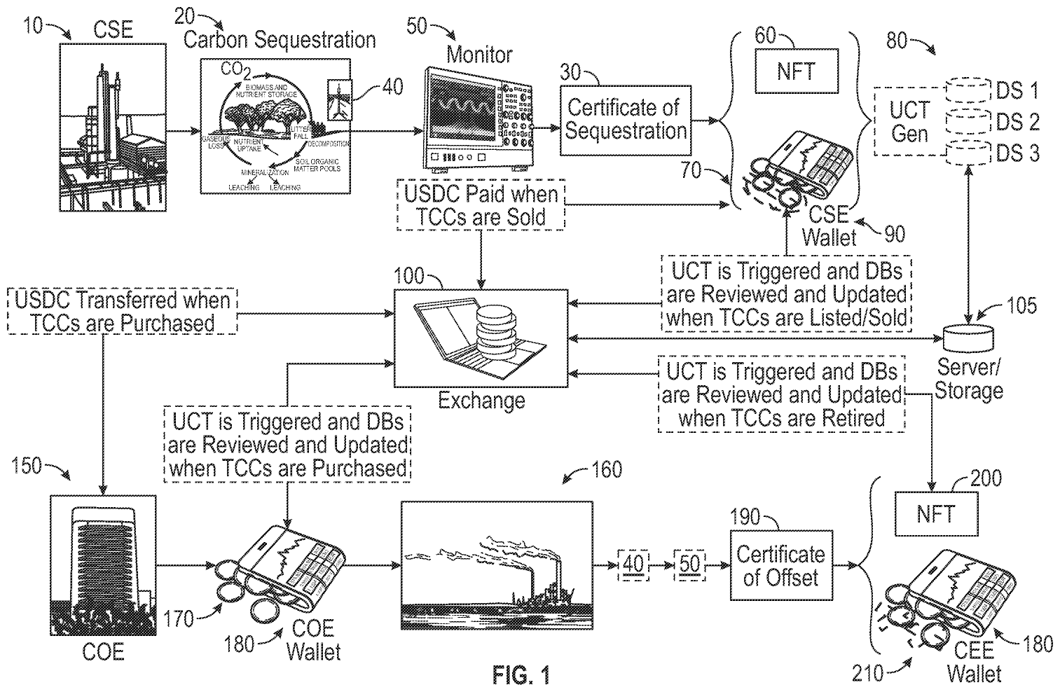

FIG. 1 shows a system for controlling and managing atmospheric carbon emissions according to embodiments. A corporation, also referred to as a first carbon sequestering entity or first-CSE 10, sequesters carbon 20. A first amount of the sequestered carbon is measured and a first certificate of sequestration (first-COS) 30 is issued, which may be automatic by a system or by a third party authority. For example, sensors 40 and monitors 50 may be utilized to electronically monitor the amount of sequestered carbon, and data may be transmitted (e.g., wirelessly) to a system server or a third-party server from which the first-COS is generated.

The system mints a first sNFT 60 (an sNFT, generally, is an NFT related to a sequestering activity) from the first-COS and generates a first set of tokens that are first tokenized carbon credits (first-TCCs) 70 representing the volume of carbon sequestered to the first-CSE as identified under the first-COS. In the embodiments, one TCC or a fraction thereof is equivalent to one ton or a fraction thereof of sequestered carbon. The system generates a first unique carbon tag (a first-UCT) 80 that is a protocol that links only the first-TCCs and the first-sNFT, which is stored on a database on a system server 105. Under its protocol, the UCT is triggered by any event that is discussed herein, such as listing, selling, transferring and burning TCCs, and information is obtained by triggering the UCT, such as whether there are enough TCCs associated with the associated COS to complete a transaction. In addition, under the UCT protocol, databases are updated based on the transactions, as indicated in greater detail below. That is, the UCT are triggered for reviewing and updating the datasets with each transaction associated with the associated TCCs until the associated TCCs are retired following offsetting activities.

Under the UCT protocol, the first-UCT has (and all UCTs have) three datasets associated with it, including a first dataset DS1, which identifies the first-sNFT, a second dataset DS2, which identifies the number of TCCs that are included in the first-TCCs (i.e., an amount of carbon identified under the first-COS), and a third dataset DS3, which identifies a location of each of the TCCs in the first-TCCs 70, e.g. within the wallet 90 of the first-CSE 10.

The system also administers a token exchange (e.g., a crypto exchange or blockchain) 100, which may be a publicly facing exchange. The first sNFT 60 is located on the exchange 100 for public verification at any time. At a time of its choosing, the first-CSE 10 may decide to list one or more of the TCCs of the first-TCCs 70 on the exchange 100, and the first-UCT 80 is updated to reflect this state of the first-TCCs 70.

The first-CSE 10 may have multiple sets of TCCs based on sequestering activities that were linked by different COSs and thus to different UCTs. When listing TCCs on the exchange 100, the system applies a FIFO (first in, first out) analysis such that TCCs associated with an earlier generated COS are listed on the exchange 100 and offered for sale before TCCs associated with a later generated COS. The related UCT is triggered to determine if there are enough related TCCs to complete the transaction.

Another corporation, also referred to as a first carbon offsetting entity (or first-COE) 150 may want to emit carbon 160. The first-COE 150 may go onto the exchange 100 and view different TCCs available from different CSEs and thus generated from different COS s and be associated with different UCTs. When the first-COE 150 selects the TCCs offered from a CSE, the TCCs it obtains from the CSE are based on a FIFO analysis.

For example the TCCs from the first-CSE 10 may be associated with multiple COSs and therefore multiple UCTs. The first-TCCs 70 associated with the first-UCT 80 may be the earliest generated TCCs for the first-CSE 10. When the first-COE selects TCCs from the first-CSE 10, the first-TCCs 70 associated with the first-COS and therefore the first-UCT 80 are sold to the first-COE 10 before other TCCs from the first-CSE 10. The first-COE 150 may purchase less than all of the TCCs associated with the first-COS, and those purchased TCCs (a subset of the TCCs associated with the first-COS) will be referred to as purchased-TCCs 170.

At the time of sale, money is paid to the exchange, in the form of USD coins, tokens or stablecoins (USDCs, USDT(s) or DAI(s)), as nonlimiting examples, which then flows to the first-CSE 10, and the first-UCT 80 triggered to updated the DS s to indicate the new location of the purchased-TCCs 170, which is the crypto wallet (for simplicity, a wallet) 180 of the first-COE 150.

At a later time, the first-COE 170 may decide to burn carbon. The TCCs associate with the amount of burned carbon, referred to as offset-TCCs 210, are selected from the TCCs in the wallet of the first-COE 150 based on FIFO if they are associated with different COS s and therefore different UCTs. A first certificate of offset (first-COO) 190 is issued along with an oNFT 200 (an NFT created from offsetting activities) based off the offset-TCCs, which is placed on the exchange 100 for public verification at any time. In the circumstance where only the first-TCCs 70 are associated with the burn activity, the first-UCT 80 is triggered and the datasets are updated to indicate that the related first-TCCs 70 are retired. If TCCs from additional COS s are implicated, additional UCTs will be triggered as well to up their respective datasets based on burning of their TCCs. In an aspect, sensors 40 and monitors 50 may be utilized to electronically monitor the amount of carbon burned, and data may be transmitted (e.g., wirelessly) to a system server or a third-party server from which the first-COO is generated.

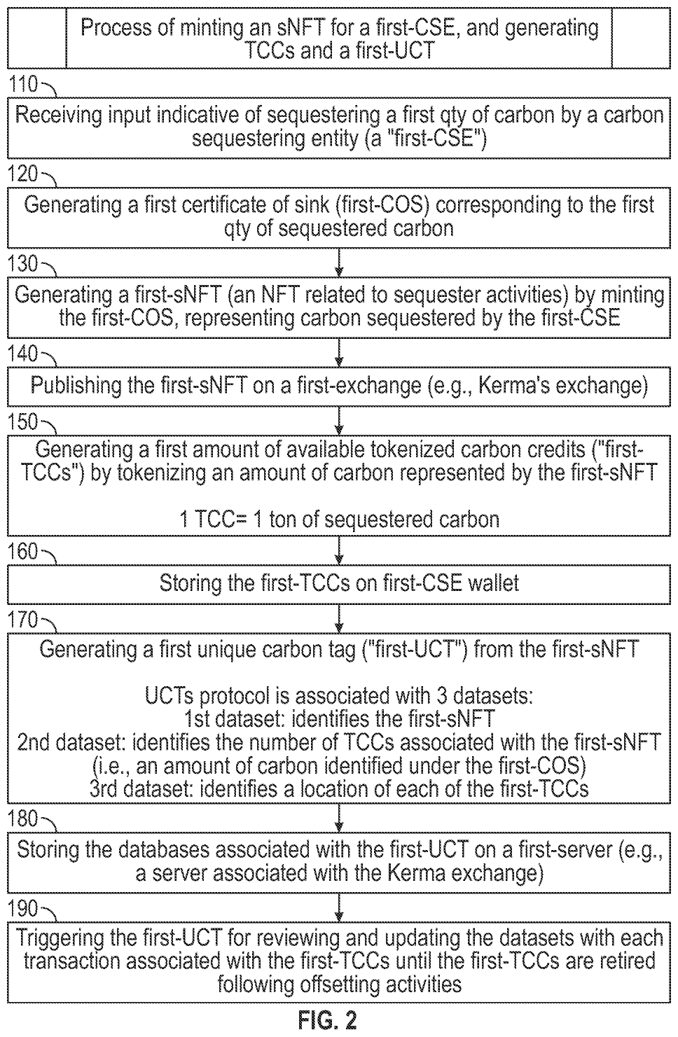

Turning to FIG. 2, a flowchart shoes a process for controlling and managing atmospheric carbon emissions utilizing the system shown in FIG. 1. Specifically the process shown in FIG. 2 is minting a first-sNFT 60 for the first-CSE 10, and generating a first-UCT 80. As shown in block 110, the process includes receiving input indicative of sequestering of a first quantity of carbon by the first-CSE 10. Such input may be from sensors 20 and monitoring apparatuses 50, or may be from user input in a computing system that monitors for such sequestering.

As shown in block 120, the method includes generating a first certificate of sink (COS 30) corresponding to the first quantity of sequestered carbon. Such generation may come from a governing authority, though automated electronic generation is within the scope of the embodiments. As shown in block 130, the method includes generating, by the system, a first-sNFT 60 related to sequester activities by minting the first-COS 30. As shown in block 140, the method includes publishing the first—sNFT 60 on the exchange 100 and providing access to the first-sNFT 60 via a first-CSE 10 storage unit, which may be the wallet of the first-CSE 10 (for simplicity storage units of the CSE and later defined COEs are referenced as their wallets). As shown in block 150, the method includes generating a first amount of available tokenized carbon credits (the first-TCCs 70) by tokenizing the amount of carbon represented by the first-sNFT 60. One TCC may be equivalent to one ton of sequestered carbon identified in the first-COS 30.

As shown in block 160, the method includes storing the first-TCCs 70 on the first-CSE 10 wallet 90. As shown in block 170, the method includes generating a first unique carbon tag (UCT 80) from the first-sNFT 60. As indicated, the protocol of the first-UCT 80 is associated with three datasets. The first dataset DS1 identifies the first-sNFT 60. The second dataset DS2 identifies the number of TCCs that are included in the first-TCCs 70 because they are associated with the first-sNFT 60, i.e., corresponding with the amount of carbon identified under the first-COS 30, and the status of each of the TCCs. The third dataset DS3 identifies a storage unit (e.g., wallet) or published location (e.g., exchange 100) of each of the first-TCCs 70.

As shown in block 180, the method includes storing the datasets associated with the first-UCT 80 on the first-server 105 associated with the exchange 100. With the first-UCT 80, the first-TCCs 70 are linked with the first-sNFT 60. No other TCCs or NFTs will be linked together via the first-UCT 80, and regardless of downstream activities, the datasets of the first-UCT 80 will always identify the current state of the first-TCCs 70. As indicated in block 190, the method includes triggering the first-UCT 80 to enable reviewing and updating the datasets with each transaction associated with the first-TCCs 70 until the first-TCCs 70 are retired following offsetting activities.

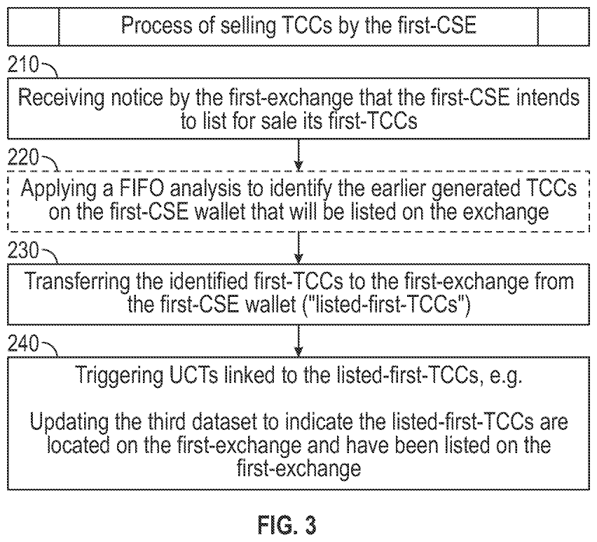

FIG. 3 shows a process of selling TCCs by the first-CSE 10. As shown in block 210, the process includes receiving a request by the exchange 100 that the first-CSE 10 intends to list for sale a first amount of its first-TCCs 70, which may be a subset or all of the TCCs stored within the first-CSE 10 storage unit, e.g., its wallet.

As indicated, the first-CSE 10 may have TCCs from more than one sequestering transaction and thus be associated with different COS s, and therefore different UCTs. If that is the case, then as shown in block 220, the method includes applying the FIFO analysis to identify which COS for the associated TCCs was generated first, and those associated TCCs would be first listed on the exchange 100. During the FIFO analysis, the system also confirms there are enough TCCs available, i.e., associated with the relevant COS, for the transaction. It is to be appreciated that block 220 is in dashed lines because it is conditioned on the first-CSE 10 having TCCs associated with different COSs and therefore different UCTs. That is, an earlier available TCC associated with the first-CSE 10 will be listed on the exchange 100 before a later generated TCC.

As shown in block 230, the method includes transferring the identified TCCs of the first-TCCs 70 to the exchange 100 from the first-CSE's wallet. Those TCCs of the first-TCCs 70 listed on the exchange 100 define (e.g., are considered) listed-TCCs. As shown in block 240, the method includes triggering the first-UCT 80 to update its datasets because it is linked to the listed-TCCs. That is, the third dataset is updated to indicate the listed-TCCs are listed on the exchange 100.

It is to be appreciated that if multiple COSs associated with multiple sets of TCCs are implicated by the exchange 100 listing, then each of the associated multiple UCTs are triggered and their respective datasets are updated. For example, if the first-CSE 10 received several COSs during separate sequestering activities, each COS 30 would be minted as a separate sNFT 60 be associated with separate set of generated TCCs. If TCCs from multiple ones of the COSs are listed on the exchange 100, each of the relevant UCTs are triggered to update their datasets and identify their status as being listed on the exchange 100.

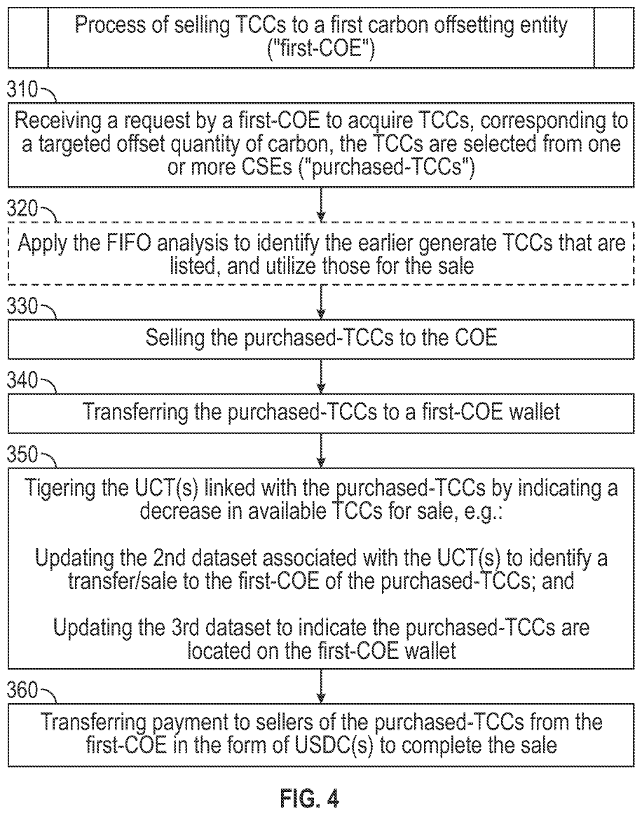

Turning to FIG. 4, a process is shown of selling TCCs to a first-COE 150. As shown in block 310, the method includes receiving a request by the first-COE 150 to acquire TCCs corresponding to, for example, a targeted offset quantity of carbon. Though the first-COE 150 may acquire TCCs for a later emission that is not necessarily defined with a targeted quantity. The first-COE 150 may select the listed-TCCs for purchase.

Alternatively, the first-COE 150 may identify for purchase TCCs from different batches of TCCs, e.g., associated with different CSEs (and thus different COSs), available on the exchange 100. The process of purchasing TCCs may be is similar to purchasing goods from an on-line marketplace, such as eBay (www.ebay.com). That is, a CSE 10 lists a certain amount of TCCs and a COE 150 can purchase all, or less than all, of the listed TCCs from one or more of the listings, e.g., based on price and availability, as non-limiting reasons. If the COE 150 selects TCCs from different CSEs, as shown in block 320, the system will apply the FIFO analysis to the selected batches of TCCs to identify the earlier generated COS for the TCCs that are listed, and utilize those associated TCCs for the sale. During the FIFO analysis, the system also triggers the associated UCTs to confirm there are enough TCCs available for the transaction. It is to be appreciated that block 320 is in dashed lines because it is conditioned on the first-COE 150 selecting TCCs associated with different CSEs (and thus different COSs).

As shown in block 330, the method includes selling the purchased-TCCs to the COE 150. As shown in block 340, the method includes transferring the purchased-TCCs to a first-COE 150 wallet 180. As shown in block 350, the method includes triggering the UCTs associated with the purchased-TCCs to update the datasets and indicate a decrease in available TCCs for sale. This includes updating the second dataset to identify a transfer/sale to the first-COE 150 of the associated TCCs. This also includes updating the third dataset to indicate that the associated TCCs are located on the first-COE 150 wallet. If the purchased-TCCs include some or all of the first-TCCs 70, which are associated with the same COS (the first-COS), then first-UCT 80 is triggered at this time. If additional COSs are implicated then their UCTs are triggered as well.

As shown in block 360, the method includes transferring payment to sellers of purchased-TCCs 170 in the form of USDC(s), USDT(s) or DAI(s) to complete the sale to the first-COE 150. For example if the purchased-TCCs 170 include some or all of the first-TCCs 70 then USDC(s), USDT(s) or DAI(s) are transferred to the first-CSE 10 to complete the sale.

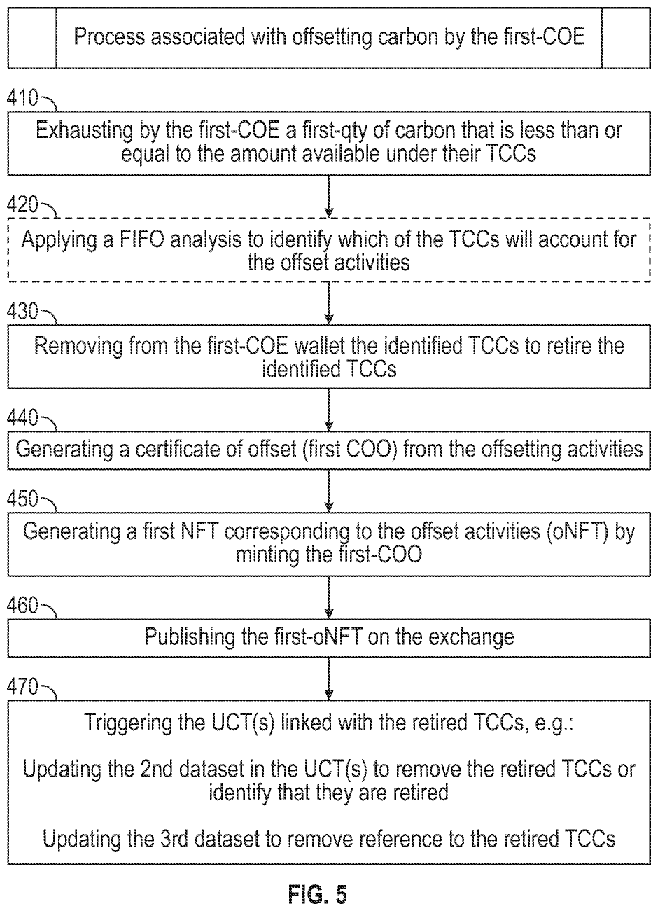

Turning to FIG. 5, a process of offsetting carbon by the first-COE 150 is shown. As shown in block 410, the method includes exhausting or offsetting by the first-COE 150 a first-quantity of carbon that is less than or equal to the amount available under the purchased-TCCs 170 stored in the first-COE 150 wallet. As shown in block 420, if the purchased-TCCs 170 are associated with different COSs from one CSE or different CSEs, and therefore different UCTs are implicated, then the system applies a FIFO analysis to identify which of the TCCs will account for the offset activities. It is to be appreciated that block 420 is in dashed lines because it is conditioned on the first-COE 150 having TCCs associated with different COSs, and therefore implicating different UCTs. TCCs that the system associates with the offset activity will be referred to as offset-TCCs 210. As shown in block 430, the method includes removing from the first-COE 150 wallet the offset-TCCs 210 to retire the same.

As shown in block 440, the method includes generating a first certificate of offset (COO) from the offsetting activities, which includes reference to the offset-TCCs 210. As shown in block 450, the method includes generating an NFT corresponding to the offset activities (oNFT) by minting the first-COO 190. As shown in block 450, the method includes publishing the first-oNFT on the exchange 100 for continued public verification.

As shown in block 470, the method includes triggering the UCTs linked with the offset-TCCs 210. This includes updating the second dataset DS2 associated with the UCTs to identify that the offset-TCCs 210 are retired. This also includes updating the third dataset DS3 to remove reference to the offset-TCCs 210, as they are burned and no longer on the wallet of the first COE 150.

The embodiments provide for control of the output of carbon emissions so as to balance with carbon sequestering and while diminishing carbon emissions over time. Specifically, carbon emissions can only follow from carbon sequestering with the disclosed system. The ability of emitting carbon may be controlled by limiting an ability to obtain tokens generated from sequestering. With a measured approach to decreasing the availability of the tokens, carbon emissions from emitting entities may cease over time, resulting in a cleaner and more sustainable environment.

Wireless connections identified above may apply protocols that include local area network (LAN, or WLAN for wireless LAN) protocols and/or a private area network (PAN) protocols. LAN protocols include WiFi technology, based on the Section 802.11 standards from the Institute of Electrical and Electronics Engineers (IEEE). PAN protocols include, for example, Bluetooth Low Energy (BTLE), which is a wireless technology standard designed and marketed by the Bluetooth Special Interest Group (SIG) for exchanging data over short distances using short-wavelength radio waves. PAN protocols also include Zigbee, a technology based on Section 802.15.4 protocols from the IEEE, representing a suite of high-level communication protocols used to create personal area networks with small, low-power digital radios for low-power low-bandwidth needs. Such protocols also include Z-Wave, which is a digiwireless communications protocol supported by the Z-Wave Alliance that uses a mesh network, applying low-energy radio waves to communicate between devices such as appliances, allowing for wireless control of the same.

Other applicable protocols include Low Power WAN (LPWAN), which is a wireless wide area network (WAN) designed to allow long-range communications at a low bit rates, to enable end devices to operate for extended periods of time (years) using battery power. Long Range WAN (LoRaWAN) is one type of LPWAN maintained by the LoRa Alliance, and is a media access control (MAC) layer protocol for transferring management and application messages between a network server and application server, respectively. Such wireless connections may also include radio-frequency identification (RFID) technology, used for communicating with an integrated chip (IC), e.g., on an RFID smartcard. In addition, Sub-1 Ghz RF equipment operates in the ISM (industrial, scientific and medical) spectrum bands below Sub 1 Ghz—typically in the 769-935 MHz, 315 Mhz and the 468 Mhz frequency range. This spectrum band below 1 Ghz is particularly useful for RF IOT (internet of things) applications. Other LPWAN-IOT technologies include narrowband internet of things (NB-IOT) and Category M1 internet of things (Cat M1-IOT). Wireless communications for the disclosed systems may include cellular, e.g. 2G/3G/4G (etc.). The above is not intended on limiting the scope of applicable wireless technologies.

Wired connections identified above may include connections (cables/interfaces) under RS (recommended standard)-422, also known as the TIA/EIA-422, which is a technical standard supported by the Telecommunications Industry Association (TIA) and which originated by the Electronic Industries Alliance (EIA) that specifies electrical characteristics of a digital signaling circuit. Wired connections may also include (cables/interfaces) under the RS-232 standard for serial communication transmission of data, which formally defines signals connecting between a DTE (data terminal equipment) such as a computer terminal, and a DCE (data circuit-terminating equipment or data communication equipment), such as a modem. Wired connections may also include connections (cables/interfaces) under the Modbus serial communications protocol, managed by the Modbus Organization. Modbus is a master/slave protocol designed for use with its programmable logic controllers (PLCs) and which is a commonly available means of connecting industrial electronic devices. Wireless connections may also include connectors (cables/interfaces) under the PROFibus (Process Field Bus) standard managed by PROFIBUS & PROFINET International (PI). PROFibus which is a standard for fieldbus communication in automation technology, openly published as part of IEC (International Electrotechnical Commission) 61158. Wired communications may also be over a Controller Area Network (CAN) bus. A CAN is a vehicle bus standard that allow microcontrollers and devices to communicate with each other in applications without a host computer. CAN is a message-based protocol released by the International Organization for Standards (ISO). The above is not intended on limiting the scope of applicable wired technologies.

As indicated, when data is transmitted over a network between end processors, the data may be transmitted in raw form or may be processed in whole or part at any one of the end processors or an intermediate processor, e.g., at a cloud service or other processor. The data may be parsed at any one of the processors, partially or completely processed or complied, and may then be stitched together or maintained as separate packets of information.

Each processor identified herein may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory identified herein may be but is not limited to a random access memory (RAM), read only memory (ROM), or other electronic, optical, magnetic or any other computer readable medium. Embodiments can be in the form of processor-implemented processes and devices for practicing those processes, such as processor. Embodiments can also be in the form of computer code based modules, e.g., computer program code (e.g., computer program product) containing instructions embodied in tangible media (e.g., non-transitory computer readable medium), such as floppy diskettes, CD ROMs, hard drives, on processor registers as firmware, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The terminology used herein is for the purpose of describing particular embodiments only and is not intended to be limiting of the present disclosure. The term “about” is intended to include the degree of error associated with measurement of the particular quantity and/or manufacturing tolerances based upon the equipment available at the time of filing the application. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A system for controlling and managing atmospheric carbon emissions, wherein the system includes one or more controllers configured for executing a first process of:
receiving input indicative of sequestering a first quantity of carbon by a first carbon sequestering entity (CSE);
generating a first certificate of sink (COS) corresponding to the first quantity of sequestered carbon;
generating a first s-NFT, that is an NFT related to sequester activities, by minting the first-COS;
publishing the first-sNFT on an exchange;
generating a first amount of available tokenized carbon credits (first-TCCs) by tokenizing an amount of carbon represented by the first-sNFT;
storing the first-TCCs on a first-CSE wallet;
generating a first unique carbon tag (UCT) from the first-sNFT, the UCT being associated with datasets, including:
a first dataset that identifies the first-sNFT;
a second dataset that identifies the number of TCCs associated with the first-sNFT, which corresponds with an amount of carbon identified under the first-COS and the status of each TCC;
a third dataset that identifies a storage or published location of each of the first-TCCs;
storing the first-UCT and the datasets on a server associated with the exchange; and
triggering the first-UCT for reviewing and updating the datasets with each transaction associated with the first-TCCs until the first-TCCs are retired following offsetting activities.

2. The system of claim 1, wherein one TCC corresponds with 1 metric ton of sequestered carbon.

3. The system of claim 2, wherein the one or more controllers configured for executing a second process of:
receiving a request from the first-CSE to list for sale the first-TCCs on the exchange; or
receiving a request from the first-CSE to list for sale the TCCs stored within the first-CSE wallet that are associated with different COS s, and applying a FIFO analysis to identify earlier generated ones of the TCCs to list on the exchange;
transferring TCCs to the exchange to define listed-TCCs; and
triggering the UCTs that are linked to the listed-TCC by updating the third dataset to indicate the listed-TCCs are listed on the crypto exchange.

4. The system of claim 3, wherein the one or more controllers configured for executing a third process of:
receiving a request by a first carbon offsetting entity (COE) to acquire one or more of the listed-TCCs from the exchange;
selling the one or more of the listed—TCCs to the COE, to define purchased-TCCs;
transferring the purchased-TCCs to the to a first-COE wallet;
triggering the UCTs linked with the purchased-TCCs to indicate a decrease in available TCCs for sale, by:
updating the second dataset to identify a sale to the first-COE of the purchased-TCCs; and
updating the third dataset to indicate the purchased-TCCs are located on the first-COE storage unit; and
transferring payment from the first-COE to sellers of the purchased-TCCs, via the exchange, in the form of USDC(s), USDT(s) or DAI(s).

5. The system of claim 4, wherein the one or more controllers configured for executing a fourth process of:
offsetting carbon by the first-COE, wherein:
the purchased-TCCs that account for the offset carbon are each associated with the first-UCT and define offset-TCCs; or
the purchased-TCCs that account for the offset carbon are associated with different COSs, and the system applies a FIFO analysis to identify the purchased-TCCs that were generated first and thereby define the offset-TCCs;
retiring the offset-TCCs;
generating a first certificate of offset (COO) from the offset-TCCs;
generating a first oNFT, that is an NFT related to offset activities, by minting the first-COO;
publishing the first-oNFT on the first-exchange;
triggering the UCTs linked with the offset-TCCs to update the datasets, by:
updating the second dataset in the UCTs to identify that the offset-TCCs are retired; and
updating the third dataset to remove reference to the retired TCCs.

6. A method for controlling and managing atmospheric carbon emissions, wherein the method includes one or more controllers executing a first process of:
receiving input indicative of sequestering a first quantity of carbon by a first carbon sequestering entity (CSE);
generating a first certificate of sink (COS) corresponding to the first quantity of sequestered carbon;
generating a first s-NFT, that is an NFT related to sequester activities, by minting the first-COS;
publishing the first-sNFT on an exchange;
generating a first amount of available tokenized carbon credits (first-TCCs) by tokenizing an amount of carbon represented by the first-sNFT;
storing the first-TCCs on a first-CSE wallet;
generating a first unique carbon tag (UCT) from the first-sNFT, the UCT being associated with datasets, including:
a first dataset that identifies the first-sNFT;
a second dataset that identifies the number of TCCs associated with the first-sNFT, which corresponds with an amount of carbon identified under the first-COS and the status of each TCC;
a third dataset that identifies a storage or published location of each of the first-TCCs;
storing the first-UCT and the datasets on a server associated with the exchange; and
triggering the first-UCT for reviewing and updating the datasets with each transaction associated with the first-TCCs until the first-TCCs are retired following offsetting activities.

7. The method of claim 6, wherein one TCC corresponds with 1 metric ton of sequestered carbon.

8. The method of claim 7, wherein the method includes the one or more controllers executing a second process of:
receiving a request from the first-CSE to list for sale the first-TCCs on the exchange; or
receiving a request from the first-CSE to list for sale the TCCs stored within the first-CSE wallet that are associated with different COSs, and applying a FIFO analysis to identify earlier generated ones of the TCCs to list on the exchange;
transferring TCCs to the exchange to define listed-TCCs; and
triggering the UCTs that are linked to the listed-TCC by updating the third dataset to indicate the listed-TCCs are listed on the crypto exchange.

9. The method of claim 8, wherein the method includes the one or more controllers configured executing a third process of:
receiving a request by a first carbon offsetting entity (COE) to acquire one or more of the listed-TCCs from the exchange;
selling the one or more of the listed—TCCs to the COE, to define purchased-TCCs;
transferring the purchased-TCCs to the to a first-COE wallet;
triggering the UCTs linked with the purchased-TCCs to indicate a decrease in available TCCs for sale, by:
updating the second dataset to identify a sale to the first-COE of the purchased-TCCs; and
updating the third dataset to indicate the purchased-TCCs are located on the first-COE storage unit; and
transferring payment from the first-COE to sellers of the purchased-TCCs, via the exchange, in the form of USDC(s), USDT(s) or DAI(s).

10. The method of claim 9, wherein the method includes the one or more controllers executing a fourth process of:
offsetting carbon by the first-COE, wherein:
the purchased-TCCs that account for the offset carbon are each associated with the first-UCT and define offset-TCCs; or
the purchased-TCCs that account for the offset carbon are associated with different COSs, and the system applies a FIFO analysis to to identify the purchased-TCCs that were generated first and thereby define the offset-TCCs;
retiring the offset-TCCs;
generating a first certificate of offset (COO) from the offset-TCCs;
generating a first oNFT, that is an NFT related to offset activities, by minting the first-COO;
publishing the first-oNFT on the first-exchange;
triggering the UCTs linked with the offset-TCCs to update the datasets, by:
updating the second dataset in the UCTs to identify that the offset-TCCs are retired; and
updating the third dataset to remove reference to the retired TCCs.
